(19) United States
(12) Patent Application Publication
(10) Pub. No.: US 2009/0009364 A1
(43) Pub. Date: Jan. 8, 2009

(54) COMMUNICATION AND FALL DETECTION SYSTEMS FOR A RIDER BEING TOWED BY A WATER VEHICLE

(76) Inventors: Luc St-Pierre, Quebec (CA); Pierre Gaudet, Quebec (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/047,031

(22) Filed: Mar. 12, 2008

Related U.S. Application Data
(60) Provisional application No. 60/906,218, filed on Mar. 12, 2007.

(51) Int. Cl. G08B 23/00

(52) U.S. Cl. 340/984

(57) ABSTRACT

A fall detection system informs a driver of a water vehicle of a fallen rider being towed by the vehicle. The system includes a detection device coupled to a handle for detecting contact between the rider and the handle. The device generates a contact signal that automatically stops or changes if contact is broken. The system further includes a transmitter coupled to the detection device that transmits a contact signal therefrom and a receiver that receives the contact signal. A display presents a warning message upon an interruption in the reception of the contact signal. Alternatively, the transmitter may be coupled to a speed control unit of the vehicle to stop or reduce the speed of the vehicle if a fall is detected. A communication system may also be provided.

### FIELD OF THE INVENTION

The present invention relates to the field of waterskiing or the like and more particularly concerns a system allowing an improved communication between a vehicle operator and a person being towed.

### BACKGROUND OF THE INVENTION

A lot of popular water sports involve one or more persons being towed by a vessel such a recreational boat, a jet boat, a personal watercraft, etc. Waterskiing is a well know example of such activities, which also include wakeboarding, inflatable tube riding, kneeboarding, wakeskating, hydrofoiling and the like. In the description below, the towing vessel will be generally referred to as the “vehicle”, and the person being towed as the “rider”, and one skilled in the art will understand that these expression may refer to any of the alternatives mentioned above or other equivalents thereof.

Most rules and regulations associated with such water sports cite that towing a rider behind a vehicle requires as a minimum a rear view mirror. This however implies that the driver must share his attention between the rear view mirror and the waterway in front of the vehicle, and chances of miscommunication with the rider are high. In addition, should the rider fall, some time may pass and a large distance may be travelled before the driver detects the fall, which could lead of course lead to serious difficulties for the rider in distress. In some states/provinces/areas, a rear-facing spotter, that is, a second person in the vehicle in addition to the driver which has been specifically assigned the task of monitoring the rider, is mandatory. Even with a dedicated spotter, however, and use of the proper hand signals, noise and all sorts of distractions may render communications from the rider to the spotter and driver difficult, long to establish or misinterpreted. For example, visible signs can signal to the driver and spotter the intent of the rider to change skiing conditions, such as increasing or decreasing speed, but not by which magnitude. Thus, speed needs to be incrementally adjusted by trial and error and it can take several iterations and time to get it to the rider's liking.

With respect to fall detection, U.S. Pat. No. 5,408,221 (CARSELLA Sr. et al.) discloses a downed rider warning system using an electronic water sensor for sensing when the tow handle lands in the water. Sensors of this type however present the disadvantage of possible false triggers if the electrodes are splashed by water during use or covered by the rider's damp skiing gloves. Furthermore, depending on the way the handle lands or bounces on the surface of the water, detection may not be instantaneous if the electrodes are not wetted enough to provide the electrical path triggering the system.

It is also known in the art to provide the tow handle with a pressure sensor built with two conductive strips normally spaced apart, making contact when sufficient pressure is applied. A break in electrical contact will cause a warning signal to be transmitted to the driver. One drawback of such a system is that water and moisture may interfere with the proper working of the electrical contacts. In addition, should the transmitter be damaged or its batteries weak, the warning signal may fail to be transmitted.

With respect to communication between the rider and driver, U.S. Pat. No. 7,109,871 (LENTINE et al.) discloses a communication system using a LED or LCD display and audible tones. Audible signals improve “skier down” and “requests to change skiing conditions” detection delay at the expense of repeated audible alarms than must be set at a higher intensity than ambient noise and music. Should the display, by design or ambient conditions, fail to attract eye contact or the intensity of the sound alarm be too weak, significant time can elapse before the driver or spotter detects the signal and take action.

In view of the above, there is therefore a need for a means to improve communication between a rider and a driver of the vehicle towing the rider, and particularly to provide for the fast detection of a fall of the rider.

### SUMMARY OF THE INVENTION

In accordance with a first aspect of the present invention, there is provided a fall detection system for informing a driver of a water vehicle of a fall of a rider being towed by the vehicle. The rider is towed through a handle connected to the vehicle through a cable or the like. The fall detection system includes a detection device coupled to the handle for detecting a contact between the rider and the handle. The detection device is adapted to generate a contact signal which automatically stops or changes if the contact is broken. The fall detection system further includes a transmitter, coupled to the detection device, for transmitting the contact signal therefrom, and a receiver, provided on the vehicle, for receiving the transmitted contact signal.

According to one embodiment of the invention, a display is further provided on the vehicle and coupled to the receiver for displaying a warning message upon an interruption in the reception of the contact signal. Alternatively, the transmitter may be directly coupled to a speed control unit of the vehicle to directly stop of reduce the speed of the vehicle if a fall is detected. In yet another alternative, other systems of the vehicle may be affected upon an interruption in the contact signal, such as for example a sound system which would lower or stop music on the vehicle to attract the driver's attention. Advantageously, the fall detection system as described above allows for the driver to be informed of the fall of the rider almost instantaneously.

In accordance with another aspect of the present invention, there is also provided a communication system for a driver of a water vehicle and a rider being towed by the vehicle. The communication system first includes an input device accessible to the driver and having at least one control activatable by the rider. The input device is adapted to generate a corresponding communication signal upon activation of each of the at least one control. The communication system further includes a transmitter, coupled to the input device, for transmitting each communication signal therefrom, and a receiver, provided on the vehicle, for receiving the transmitted communication signals. In accordance with one embodiment of the invention, the communication system includes a display provided on the vehicle and coupled to the receiver for displaying a corresponding communication message upon reception of the communication signal.

In accordance with another embodiment of the invention, the receiver may be directly connected to a speed control unit of the vehicle. In another variant, the receiver may also or alternatively be connected to the vehicle's instrumentation. The communication signals may for example be embodied by an emergency stop signal, a speed increase or decrease signal, a “page” signal or a set/resume/cancel signal.

Other features and aspects of the present invention will be better understood upon reading of preferred embodiments thereof with reference to the appended drawings.

### BRIEF DESCRIPTION OF THE DRAWINGS

FIG. 1A is a block diagram of the speed control system of a typical water vehicle.

FIG. 1B is a block diagram showing a communication system according to a first embodiment of the invention coupled to the speed control unit of the vehicle control system of FIG. 1A.

FIG. 2A is a block diagram showing a communication system according to an embodiment of the present invention incorporating a launch control system of the vehicle; FIG. 2B is a flow chart of a sequence for a launching sequence using the system of FIG. 2A.

FIG. 3 is a block diagram showing a communication and fall detection system according to a second embodiment of the invention coupled to display on the water vehicle.

FIG. 4 is a block diagram showing a communication and fall detection system according to another embodiment of the invention coupled to both the speed control unit of the vehicle and to a display on the vehicle.

FIGS. 5 through 8 are schematic representations of a handles provided with an input device of a communication and fall detection system according to several embodiments of the invention.

FIG. 9 is a schematic representation of an input device of a communication system according to yet another embodiment of the invention provided on a wristband.

FIG. 10 is a schematic representation of an input device of a communication system according to yet another embodiment of the invention provided on a tube.

FIGS. 11, 12, and 13 are schematic representations of handles provided with input devices of a fall detection system according to embodiments of the invention.

### DESCRIPTION OF PREFERRED EMBODIMENTS OF THE INVENTION

The present invention provides a communication system, a fall detection system or a combination of both for used by a rider being towed by a water vehicle. It will be understood by one skilled in the art that the even though the described embodiments show both systems as integrated, one could provide a vehicle with either a communication system or a fall detection system without departing from the scope of the present invention.

As explained above, the expression “water vehicle” or “vehicle” is used to designate any appropriate motorized vessel travelling over water such as a recreational boat, a jet boat, a personal watercraft, etc. The “driver” is used to refer to the person operating the vehicle. It is understood than more than one person may be aboard to boat and assisting this operation in some manner, so that the driver may be more than one person. For example, a spotter may be present aboard the boat to monitor the rider's activity. The expression “rider” is used herein to refer to a person being towed by the vehicle as part of a recreational sport or activity such as waterskiing, wakeboarding, inflatable tube riding, kneeboarding, wakeskating, hydrofoiling and the like. The rider is towed by the vehicle through a handle connected to vehicle by a cable or the like.

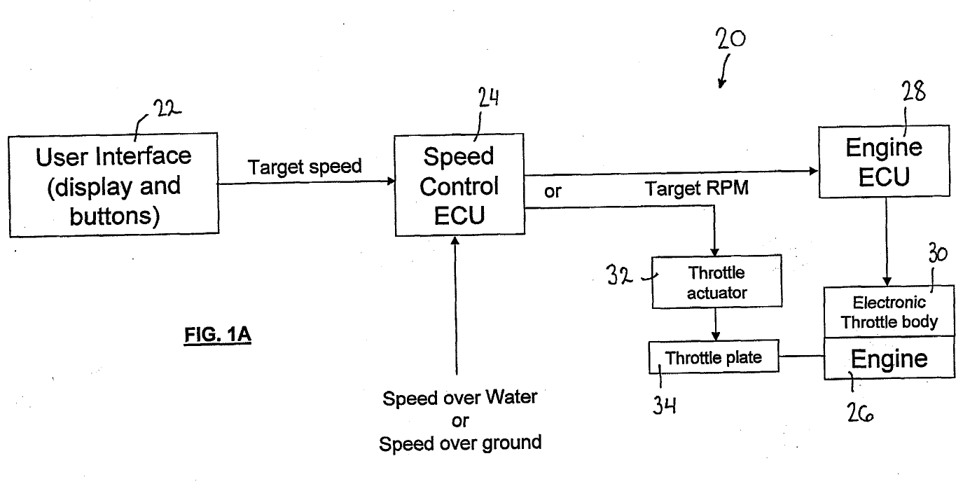

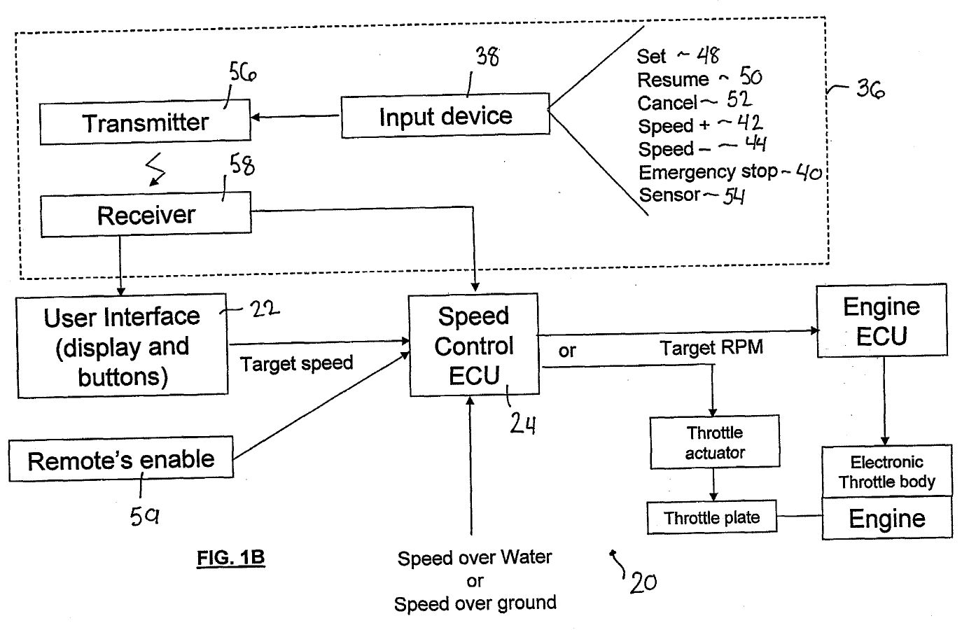

Referring to FIG. 1A there is shown a typical speed control system 20 for a vehicle as defined above. The speed control system includes a user interface 22 including displays, buttons, and any component allowing the driver to control the vehicle. The user interface 22 is in communication with a speed control unit 24 and sends information about the desired target speed thereto. The speed control unit 22 calculates the required RPM necessary to provide the target speed and controls the engine 26 accordingly, either through an engine ECU 28 and Electronic throttle body 30 or through a throttle actuator 32 and throttle plate 34. Speed feedback for the control loop comes from a pitot tube, paddlewheel or other sensor giving relative vehicle speed over water. Alternately, relative speed over ground from a GPS antenna can also be used in the control loop. Of course, once skilled in the art will understand that the speed control system shown in FIG. 1A is given by way of example only and is not limitative to the field of application of the present invention.

Referring to FIG. 1B, there is shown a communication and fall detection system 36 according to a preferred embodiment of the present invention, for use with a vehicle speed control system 22 as shown in FIG. 1A. The communication and fall detection system 36 first includes an input device 38. Preferably, the input device 38 is integrated, or coupled to the handle which is held by the rider. Several embodiments of the input device 38 will be explained further below. The input device includes at least one control activatable by the rider. The input device translates each control in a particular communication signal which corresponds to a command the rider may want to communicate to the speed control unit 24 of the vehicle. The communication and fall detection system further includes a detection device, such as a sensor 54, coupled to the handle for detecting a contact between the rider and the handle. The sensor 54 is adapted to generate a contact signal which indicates that at least one hand of the rider is in contact with the handle. If it ceases to be the case, and the rider has therefore fallen, the contact signal is interrupted or replaced by a different signal. Exemplary embodiments of appropriate sensors 54 will also further be described further below.

The communication and fall detection system 36 further includes a transmitter 56 coupled to the input device to receive the contact signal or communication signals therefrom. It will be noted that although the sensor 54 is shown herein as communication with the transmitter 56 though the input device 38, it may alternatively be directly connected to the transmitter 56. The transmitter 56 transmits the signals to the vehicle, either through a wired or wireless communication link. A corresponding receiver 58 is provided on the vehicle to receive the signals from the transmitter 56. In the illustrated embodiment, the transmitter is connected to the speed control unit 24 to forward the instructions from the rider directly thereto. Additionally, in the illustrated embodiment, the transmitter is also connected to the vehicle's instrumentation unit (user interface 22) to display the instructions from the rider directly thereto.

Preferably, transmitter uses a different coded signal for each of the communication signal which is transmitted when a function is activated by the input device 38. Furthermore, the contact signal may be embodied by a specific code different from the communication signals and broadcasted continuously when the handle sensor 54 is active, eliminating the risk of missed “skier down signal” should the batteries of the transmitter become too weak, as would be the case if a signal was only broadcasted when the handle sensor released.

Optionally, a remote enabling control 59 may be provided as part of the user interface 22 of the vehicle of proximate thereto, in order to allow the driver to activate and deactivate the rider's control of the speed control unit 38 through the system 36 of the present invention. For example, the driver may wish to enable the remote speed control function when the waterway is safe, and to disable it or over-rides it when necessary. Giving the rider a direct link to the speed control system provides for faster speed corrections and adjustments. Optionally, the rider speed control could be limited to a predetermined percentage of the driver-enabled target speed.

In the illustrated embodiment, controls are preferably provided on the input device 38 for the following functions:
the “emergency stop” input 40 disengages speed control;
the “increase speed” input 42 increases the target speed of the speed control system;
the “decrease speed” input 44 decreases target speed of the speed control system; and
the “set” (48) “resume” (50) and “cancel” (52) inputs allows respectively setting the target speed, resuming a previous target speed or cancelling speed control.

It will be understood that other functions could be added to the example above and that different functions could be combined in a multitude of manners without departing from the scope of the present invention.

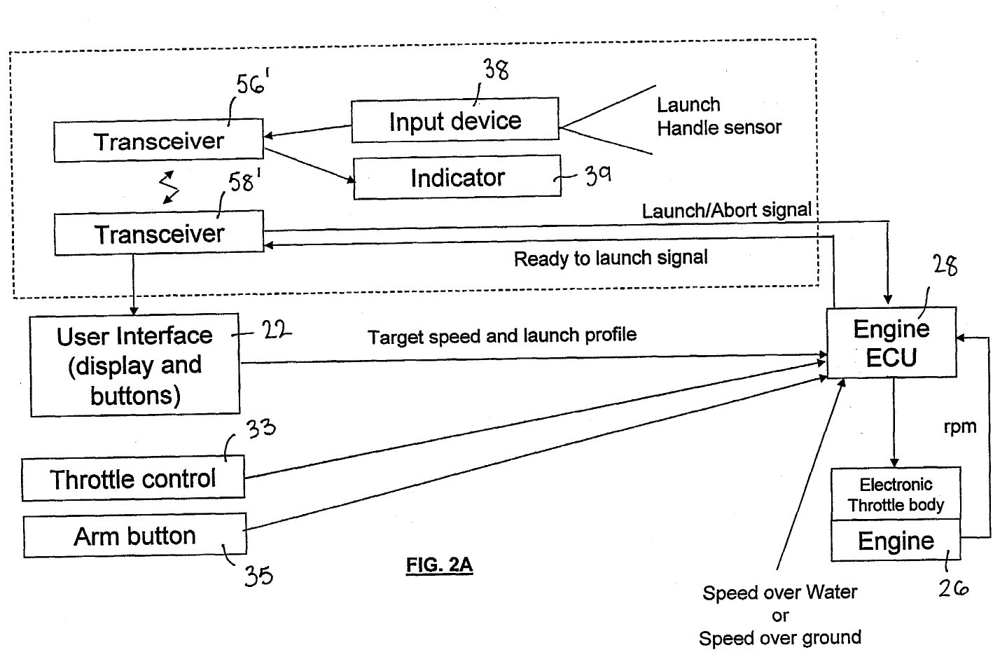

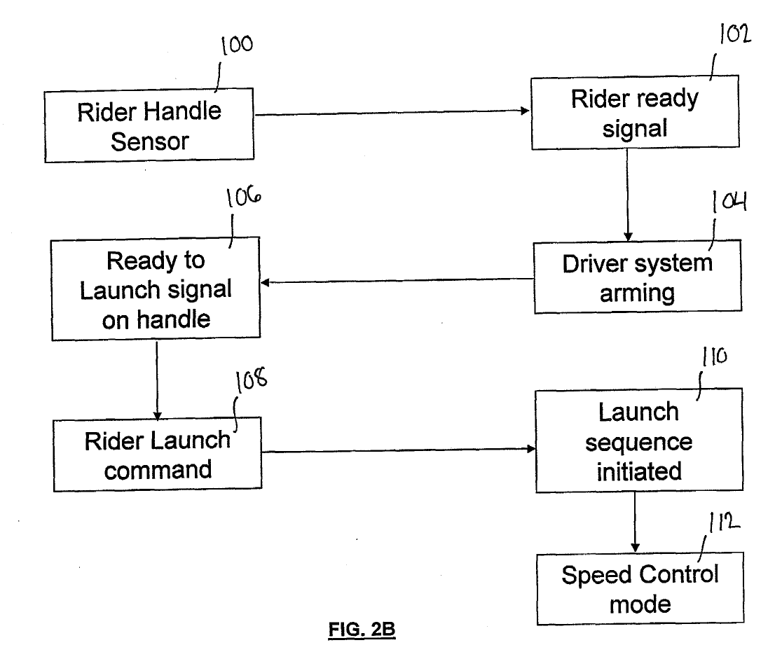

Referring to FIGS. 2A and 2B, there is shown another embodiment of the present invention. In this case, the vehicle is equipped with a ski launching system, as known in the art. In such a system, the engine 26 is fitted with an electronic throttle control 33 and electronic control unit 28, capable of delivering acceleration to the vehicle along a pre-programmed engine rpm or vehicle speed profile which specifies the required rpm and/or speed over time. A launching sequence is traditionally initiated by the driver by enabling the ski launching system, and engaging the throttle control 33 passed a certain point. Aborting launch is performed by manually taking the throttle control back. A system as this one enables consistent and repeatable accelerations but relies on good rider-driver communication for success.

In the embodiment of FIGS. 2A and 2B, the transmitter 56 and receiver 58 are replaced by transceivers 56′ and 58′ which allow two-way communication between the rider and the driver. The embodiment advantageously allows the vehicle's status and other useful information to be shown on a display or indicators 39 embedded on the tow handle. For example, a “vehicle is ready to launch” status could be indicated the rider could be warned of a potentially hazardous condition.

Bi-directional communication further makes direct interaction with a launch control system possible. A flow chart of a launch sequence using such an embodiment of the invention is shown in FIG. 2B. Once the sensor detects 100 the rider hands on the handle, an appropriate message such as “rider” ready” is transmitted 102 to the vehicle, where it may be displayed in the user interface or a separate indicator. The driver can then arm 104 the launch system, preferably through an arming control 35 (see FIG. 2A) and a “ready to launch” message may in turn be sent 106 to the handle and shown on the handle's display or indicators. The rider then sends 108 a confirmation launch command. This may for example be embodied by the rider pressing and holding a predetermined button or a combination of buttons on the input device, releasing the pressed buttons aborting the launch. Alternatively, the rider may press a predetermined button or a combination of buttons on the input device to launch, and the subsequent pressing of any button could abort the operation. The launch sequence is finally initiated 110 (either by the driver or automatically) and the vehicle launches 112 in speed control mode. Preferably, the launching sequence could be aborted at any time by either the driver or the rider. In the case of the driver, aborting may for example be achieved by pressing a cancel button or by releasing the arming button. Further preferably, the detection by the sensor on the handle of a loss of contact between the rider and handle will abort the launch sequence.

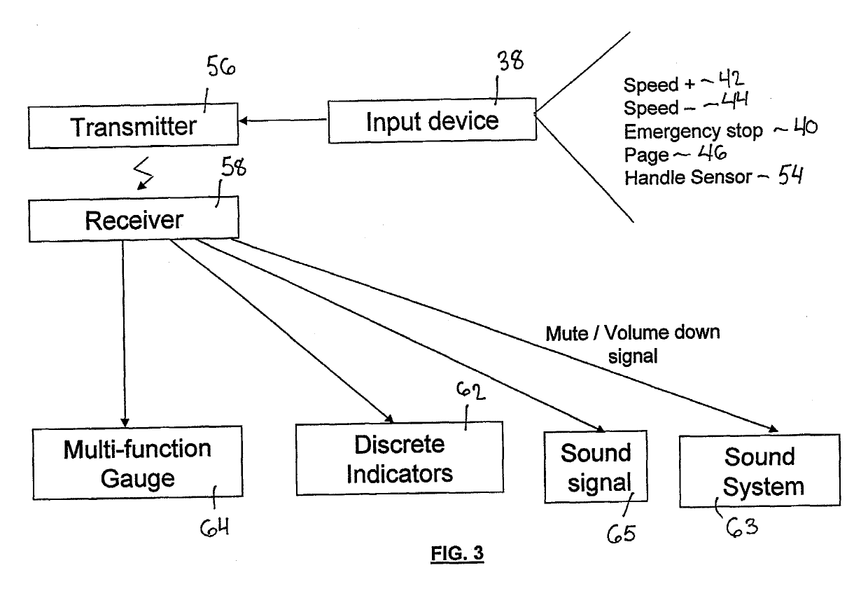

Referring to FIG. 3, there is shown another embodiment of the present invention. In this case, the signals received by the transmitter 56 of the communication and fall detection system 36 is forwarded to a display 60 which provides the driver or other occupant of the vehicle with messages representing the information transmitted from the rider. Preferably, the display 60 may be part of, integrated with or proximate to the user interface of the vehicle. In another embodiment, the display 60 may be provided at another location on the vehicle, for example for consultation by a spotter. The display 60 preferably includes discrete indicators 62, each corresponding to a given communication signal, one or more multi-function gauges 64 on which multiple signals can be displayed, or a sound signal 65 such as an alarm or buzzer. Combinations of these elements are also possible. The signals may be displayed in various forms such as blinking lights of various colors, information on a LCD screen, etc. The warning signal corresponding to a fall detection may be provided on a same display as the communication signals or separately. It should preferably be positioned and designed so that it will immediately attract the attention of the driver or another person on the vehicle when activated. In the embodiment of FIG. 3, in addition to a fall detecting sensor, the input device 38 includes increase speed 42 and decrease speed 44 inputs, which signal the corresponding request from the rider to the driver, an emergency stop input 40, which again provides a corresponding message on the display 60, as well as a “page” input 46, which activates an indicator on the display 60 which signals the driver that the rider requires his attention.

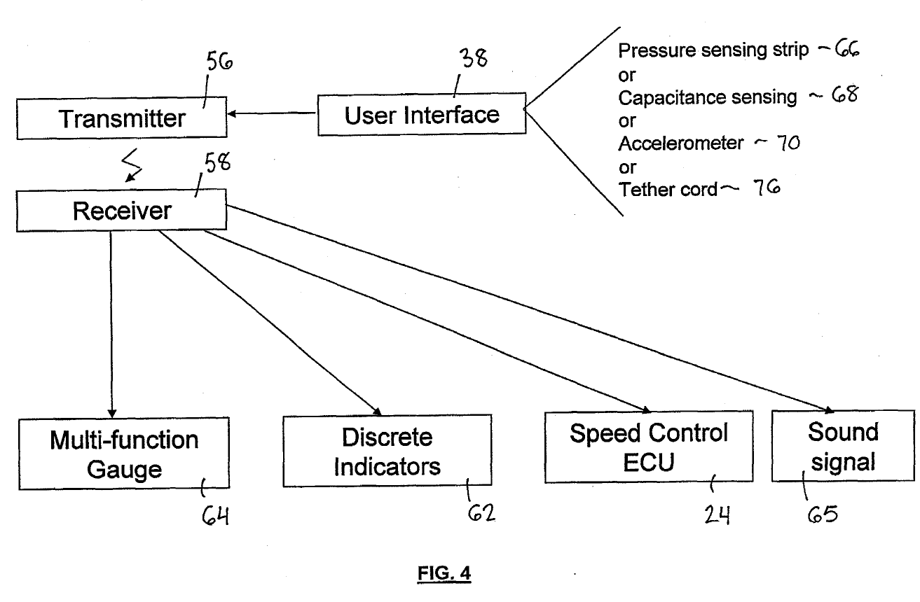

Referring to FIGS. 4 and 11 to 13, there is shown yet another embodiment of the present invention relating to a fall detection system 36 only, without a communication system. The fall detection system 36 includes a sensor 54 which, as explained above, is adapted to sense a loss of contact between the rider and the handle 82. When contact is lost and the contact signal is interrupted, a warning message may either be provided to the driver through a discrete indicator 62 or the vehicle's multi-function gauge or LCD display 64 or to the speed control unit 24 directly, or to the remote control input of a sound system 63 or any combination of them. A fall of the rider could mute of lower the volume of the sound system 63 in order to catch driver attention and/or be able to hear an audible alarm signal. A fall of the rider could also directly interact with the speed control unit 22 to disengage the cruise control and/or force a programmable coast down of the vehicle to yield a faster rider down detection and reaction time.

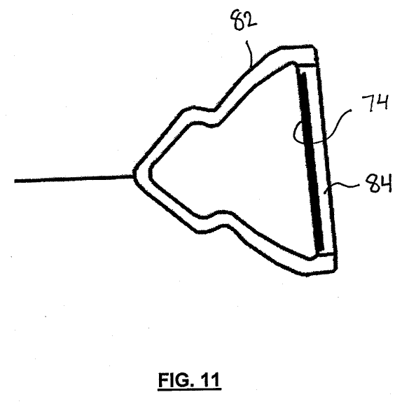

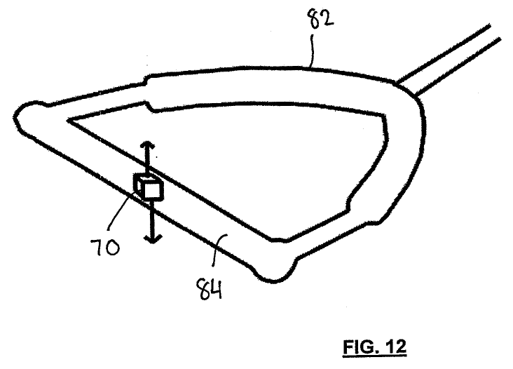

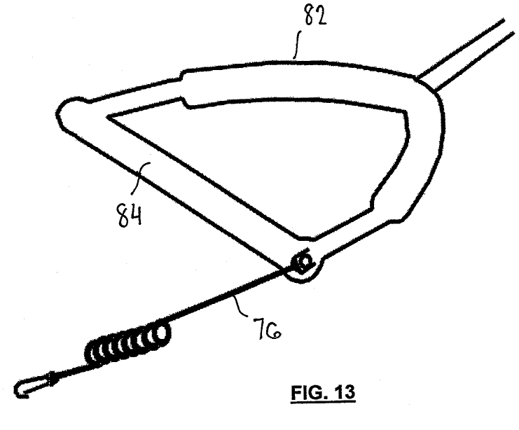

The sensor 54 may for example by embodied by a pressure sensing grip 66, including at least one pressure sensitive switch 72 extending along the inside edge of the handlebar 84. Alternatively a capacity sensing grip 68 including on or more capacity sensing cells built with two conductive strips separated by a dielectric material embedded 74 along the inside edge of the handlebar 84 may be provided (see FIG. 11). In another variant (see FIG. 12), the sensor may be embodied by an accelerometer 70 of at least a single axis perpendicular to the water emitting a signal representative of the acceleration forces of the handle 82. A low-frequency signal signifies that the handle 82 is in the rider's handle, while a high frequency signal or having spikes signifies that the handle 82 is dragging in the water or bouncing on the surface of the water. In yet another variant, the sensor 52 may be embodied by a tether cord 76 attached to the rider or to his personal flotation device 78 (see FIG. 13).

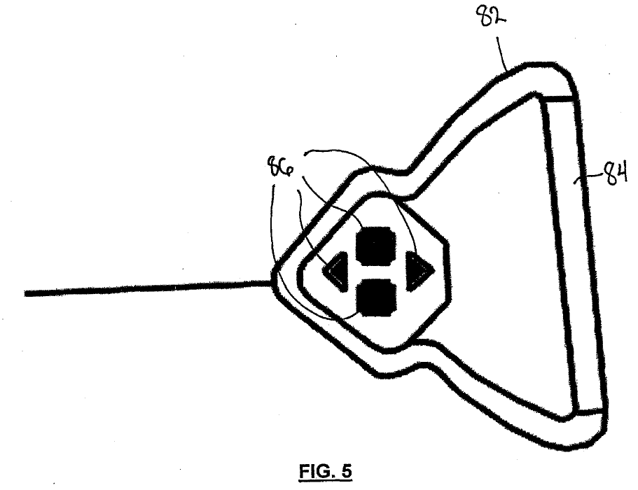

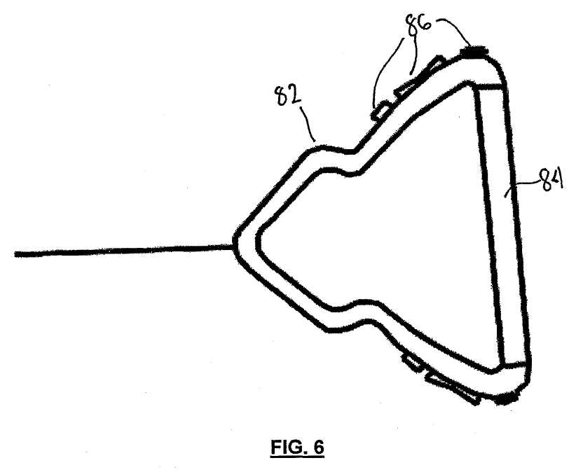

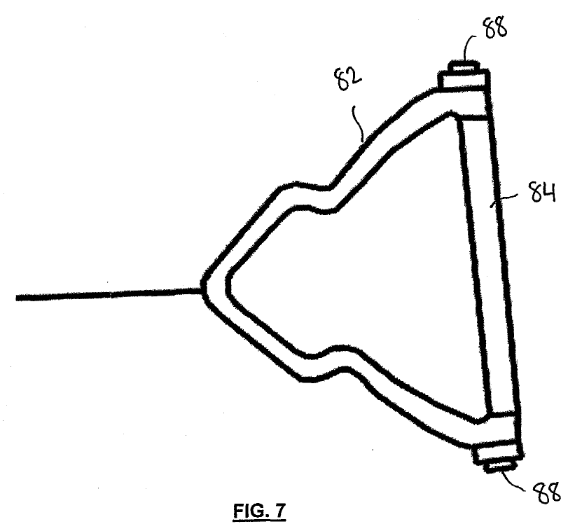

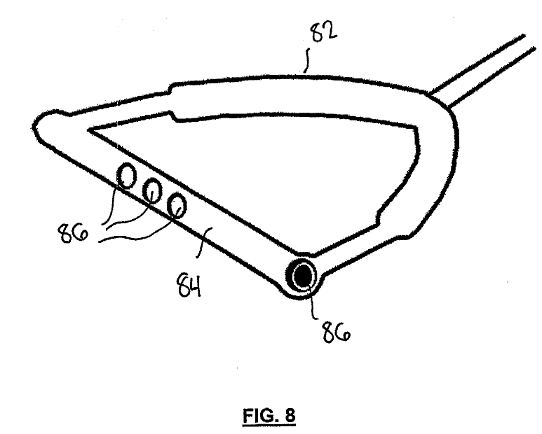

Referring to FIGS. 5 through 10, there are shown various embodiments of an input device 38 for use with the present invention. FIG. 5 shows a control pad 80 provided at a base of the triangular shape of the handle 82, opposite the handlebar 84. The pad is preferably provided with buttons 86 embodying the appropriate controls. In FIG. 6, buttons 86 are provided directly on the outside of the side arms of the handle 82. In FIG. 7, the controls are embodied by a rotary switch 88. An appropriate convention could be determined, such that a rotation of the rotary switch 88 towards the front signifies increase speed, whereas a rotation towards the rear indicates decrease speed. In the embodiment of FIG. 8, buttons 86 are embedded in the handlebar 84, both in the front and on the sides.

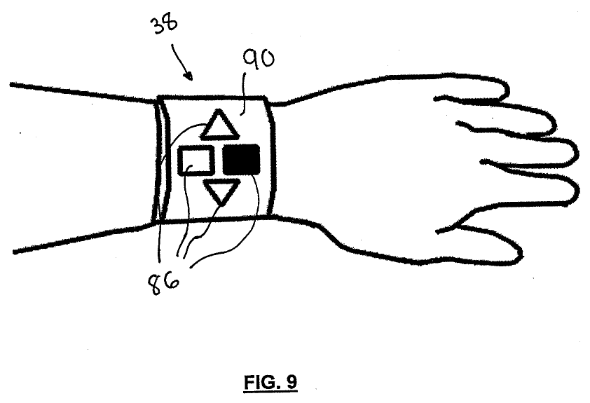

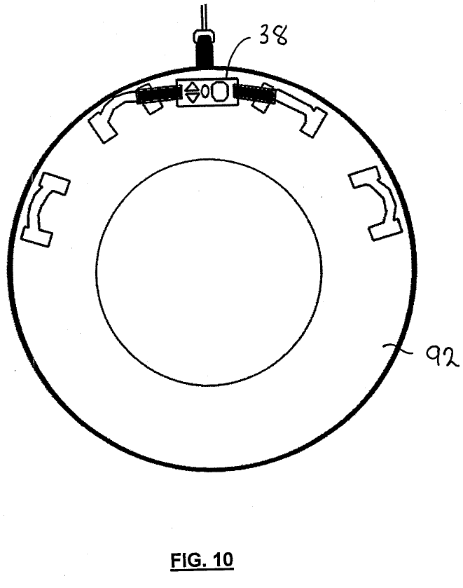

FIG. 9 shows another variant of the invention where the input device 38 is provided in a wristband 90 worn by the rider, and having buttons 86 or the like. In yet another variant, shown in FIG. 10, for tube riding the input device 38 may be provided on the tube 92 itself, proximate the point where the tube is held by the rider.

Of course, numerous modifications could be made to the embodiments described above without departing from the scope of the present invention.

1. A fall detection system for informing a driver of a water vehicle of a fall by a rider being towed by the vehicle, comprising:
a handle coupled to a water vehicle;
a detection device operably connected to the handle that detects contact between a rider and the handle and transmits a signal when contact between the rider and the handle has been detected as lost;
a warning device that receives the signal and notifies an operator of the water vehicle that contact between the rider and the handle has been lost.

2. The system of claim 1, wherein the warning device comprises a display.

3. The system of claim 2, wherein the display is operably connected to an instrumentation unit of the water vehicle.

4. The system of claim 1, wherein the warning device comprises an audible alarm.

5. The system of claim 1, wherein the warning device is operably coupled to a system of the water vehicle.

6. The system of claim 5, wherein the system of the water vehicle comprises any one of a speed control system and a sound system.

7. The system of claim 5, further comprising an input device that enables the rider to control the system of the water vehicle.

8. The system of claim 1, further comprising a communication system that enables the rider to communicate with the operator of the water vehicle.

9. The system of claim 1, wherein the detection device comprises an object worn by the rider.

10. The system of claim 1, wherein the detection device comprises any one of a pressure sensing grip and a capacity sensing grip.

11. A method of informing a driver of a water vehicle of a fall by a rider being towed by the vehicle, comprising:
detecting a loss of contact between a rider and a handle being towed by a water vehicle;
transmitting a signal when contact between the rider and the handle has been detected as lost; receiving the signal; and
notifying an operator of the water vehicle that contact between the rider and the handle has been lost.

12. The method of claim 11, further comprising displaying a warning message.

13. The method of claim 12, wherein the displaying displays the warning message on an instrumentation unit of the water vehicle.

14. The method of claim 11, further comprising emitting an audible alarm.

15. The method of claim 11, further comprising operably coupling the handle to a system of the water vehicle.

16. The method of claim 15, wherein the system of the water vehicle comprises any one of a speed control method and a sound system.

17. The method of claim 15, further comprising enabling the rider to control the system of the water vehicle.

18. The method of claim 17, further comprising enabling the rider to increase and decrease a speed of the water vehicle.

19. The method of claim 17, further comprising enabling the rider to reduce a volume of a sound system of the water vehicle.

20. The method of claim 11, further enabling the rider to communicate with the operator of the water vehicle.
